(19) United States
(12) Patent Application Publication
(10) Pub. No.: US 2018/0101192 A1
(43) Pub. Date: Apr. 12, 2018

(54) BUS ARCHITECTURE WITH REDUCED SKEW AND PEAK POWER CONSUMPTION

(71) Applicant: SK hynix Inc., Gyeonggi-do (KR)

(72) Inventors: Simone MAZZUCCHELLI, Agrate Brianza (IT); Nicola MAGLIONE, Agrate Brianza (IT)

(21) Appl. No.: 15/728,806

(22) Filed: Oct. 10, 2017

(30) Foreign Application Priority Data
Oct. 10, 2016 (IT) 102016000101497

(51) Int. Cl. G06F 1/10; G06F 13/42; G06F 13/40; G06F 1/32

(52) U.S. Cl. CPC G06F 1/10; G06F 13/4282; G06F 13/4022; G06F 1/3253; G06F 13/4059

(57) ABSTRACT

Disclosed herein is a bus architecture for transferring data from a bus signal generator to a receiver comprises a plurality of bus lines comprising a plurality of odd bus lines and a plurality of even bus lines, each of the even bus lines being arranged between adjacent odd bus lines; and at least one repeater coupled with the plurality of bus lines, wherein each of the plurality of bus lines comprises a plurality of unit length paths(ULPs), wherein the repeater is arranged between adjacent ULPs of the bus lines, wherein one of the adjacent ULPs is coupled to one among inputs of the repeater and the other of the adjacent ULPs is coupled to one among outputs of the repeater for each of the bus lines, wherein either of the odd bus lines or the even bus lines are inverting bus lines.

### CROSS-REFERENCE TO RELATED APPLICATION

The present application claims priority under 35 U.S.C. § 119(a) to Italian patent application number 102016000101497, filed on Oct. 10, 2016, the entire disclosure of which is incorporated herein by reference in its entirety.

### TECHNICAL FIELD

The present disclosure relates to a bus architecture for transferring data from a bus signal generator to a receiver and, more particularly, to a bus architecture having reduced skew and peak power consumption.

### DISCUSSION OF THE RELATED ART

In a computer or memory architecture, a bus transfers data between components. Buses can be parallel buses, which carry data words in parallel on multiple wires. As data rates increase, problems of timing skew, power consumption, electromagnetic interference and crosstalk across parallel buses become more and more difficult to overcome.

FIG. 1A shows a timing diagram of a signal transition of an ideal bus. In particular, in an ideal bus, transitions of all signals occur at the same instant. According to the ideal bus, the signal transition is thus expected to occur at an exact point of time, e.g. instants t1 and t2 of FIG. 1A. However, the situation in a real bus is different from that of the ideal bus.

FIG. 1B shows a timing diagram of a signal transition, of a real bus along with a corresponding clock signal.

The signal transitions occur in different instants, e.g. instants t2-1 for the rising transition and instants t2-2 for the falling transition. The time between the first transition instant t2-1 and the last transition instant t2-2 for the rising and the falling transitions, respectively, is defined as “SKEW”.

The “SKEW” occurs due to several reasons such as metal path mismatch, Different Transition Times (DTT), and Adjacent Lines Simultaneous Switching (ALSS). The Different Transition Times (DTT) means that the rising time is not identical to the falling time, due to the semiconductor width/length ratio (W/L), the charge mobility (μ) and the threshold voltage V_{TH} variations with Process-Voltage-Temperature (PVT) conditions variation.

The time interval in which the signals do not have transition is commonly defined as Data Valid Window t_{DVW}. The Data Valid Window t_{DVW} decreases as “SKEW” increases. A wide Data Valid Window t_{DVW} is fundamental because the data is sampled by a clock edge which can occur in different instants due to PVT conditions variation. Therefore, if the Data Valid Window t_{DVW} is not wide enough, wrong data can be sampled.

The following formula is satisfied between “SKEW” and Data Valid Window t_{DVW}.

Min (Data Valid Window t_{DVW})=T₀−Max (“SKEW”)

In the above formula, T₀ represents a signal period tied to a frequency of the bus and thus to a clock signal of the bus as represented in FIG. 1B.

As timing performances increase, faster signals must be guaranteed. In other words, the signal period T₀ decreases. This implies the “SKEW” is becoming a dominant factor. For example, when bus frequency is 200 Mbps, i.e. T₀=5 ns, the “SKEW” of about 3 ns can be unacceptable.

FIG. 2 shows a bus architecture with no Adjacent Lines Simultaneous Switching (ALSS).

The bus architecture 100-1 comprises a bus signal generator 20, a repeater 21, and a receiver 22. In the FIG. 2, six bus lines including 25_n−1, 25_n, 25_n+1, 25_m and 25_m+1 are shown, connecting the bus signal generator 20 and the repeater 21, as well as the repeater 21 and the receiver 22. A ground voltage VSSI is applied to the bus lines 25_n−1, 25_n+1, 25_m−1. This is often called as “internal shielding”. In essence, rather than providing all data lines i.e. bus lines, side by side, they are separated using not-switching lines, e.g. usually ground lines. In high speed switching data buses, internal shielding is used to avoid cross talk between lines. In fact, thanks to the ground lines alternately arranged through the data lines, Adjacent Lines Simultaneous Switching (ALSS) is prevented, each data line being surrounded by not-switching (ground) lines.

Usually, long bus lines are also split in shorter paths named as Unit Line Path (ULP) using repeater stages in order to reduce lines load and hence decrease transition times. In. FIG. 2, two ULPs including ULP1 and ULP2 are shown. In particular, ULP1 connects the bus signal generator 20 and the repeater 21, while ULP2 connects the repeater 21 and the receiver 22. It is remarked that FIG. 2 shows only one repeater 21, but in general for very long lines, more repeater stages and more ULPs can be used.

It is assumed that the worst metal path is a data bus line indicated as 25_n and the best metal path is another data bus line indicated as 25_m. More particularly, it is underlined that the worst metal path indicates that a signal flowing there through is the slowest, and the best metal path indicates that a signal flowing there through is the fastest. The best metal path can correspond, for instance, to the shortest metal line length or the largest space between two adjacent metal lines. The worst metal path can correspond to the longest metal line length or to the smallest space between two adjacent metal lines.

In FIG. 2, an intermediary skew Tₛ₀ is shown in the dashed circle 26 at the repeater stage 21, and a final skew Tₛ₁ is shown in the dashed circle 27 at the receiver stage 22. The final skew Tₛ₁ is greater than the intermediary skew Tₛ₀, because each signal flowing through the respective bus lines 25_n and 25_m can undergo a different delay along ULP2 due to, for example, the path mismatch and the ALSS.

Theoretically, drawing bus lines using exactly the same length and spacing will result in no skew increasing, but in reality the best and worst metal paths can appear.

FIGS. 3A to 3C show coupling capacitances between metal paths in an internally shielded bus architecture and in an un-shielded bus architecture, respectively.

In FIG. 3A, the bus architecture implements the internal shielding, so a first and a third metal paths (i.e., bus lines) 30-1 and 30-3 are grounded with the ground voltage VSSI. A signal with rising edge 31 is applied to a second metal path or bus line 30-2, which is intermediate between the first and third bus lines 30-1 and 30-3. The difference between the low and high voltage values of the signal 31 is ΔV.

When it is assumed that a coupling capacitance between two metal paths is C_{coup}, the coupling capacitance C_{coup} is then charged with electric charge Q. The load capacitance of the bus architecture shown in FIG. 3A and comprising one metal path or bus line with internal shielding as above described has an equivalent total coupling capacitance 2*C_{coup} of two capacitances connected in parallel, as depicted in FIG. 3A.

FIG. 3B depicts a case of an un-shielded bus architecture wherein adjacent metal paths or bus lines have a signal with a same edge polarity, in particular with rising edge.

More in particular, a signal with rising edge 31 is applied to all metal paths or bus lines 30-1, 30-2 and 30-3 of the un-shielded bus architecture. The difference between low and high voltage values of the signal 31 is ΔV. The voltage difference between the first and second metal paths or bus lines 30-1 and 30-2 as well as between the second and third metal paths or bus lines 30-2 and 30-3 is 0, since the signals flowing there through rise simultaneously. Due to this simultaneous rising, the equivalent total capacitance becomes also 0, which allows faster signal propagation through bus lines.

FIG. 3C depicts a case of an un-shielded bus architecture wherein adjacent metal paths or bus lines 30-1, 30-2 and 30-3 drive respective signals with opposite edge polarity and a corresponding modeling thereof.

In particular, it is considered that a signal with rising edge 31 is applied to the intermediate second metal path or bus line 30-2, while a signal with falling edge 32 is applied to the first metal path or bus line 30-1 and to the third metal path or bus line 30-3.

Being the difference between low and high voltage values of each signal 31 and 32 still equal to ΔV, it is immediately derived that the voltage difference between the first and second metal paths or bus lines 30-1 and 30-2 as well as between the second and third metal paths or bus lines 30-2 and 30-3 is 2*ΔV, the corresponding signals having opposite polarities.

Moreover, being the capacitance between two metal paths equal to C_{coup}, it occurs that, during the simultaneous rising and falling of the signals 31 and 32, a double charge (2*Q) is charged in each of the capacitance C_{coup}, being the electric charge Q inserted into the capacitance C_{coup} when a voltage V is applied. Hence, a total 4*Q is charged to the intermediate second metal path 30-2.

In this case, the un-shielded bus architecture can be modeled with double parallel capacitances 2*C_{coup} between adjacent lines metal paths or bus lines 30-1, 30-2 and 30-3, which causes slower signal propagation through bus lines.

It is thus concluded that, in an un-shielded bus architecture, the load capacitance between metal paths or bus lines becomes the highest when signals having opposite polarities are passing through two adjacent metal paths or bus lines, which causes the highest delay of the signal propagation, and is the worst case.

FIG. 4 shows a typical un-shielded bus architecture where the ALSS occurs.

The bus architecture 100-2 comprises a bus signal generator 20, a repeater 21, and a receiver 22. Six bus lines, i.e. metal paths 20_n−1, 20_n, 20_n+1, 25 _m−1, 25_m and 25_m+1 are shown in FIG. 4. In practical implementation, the number of the bus lines may be greater than six.

The greatest delay occurs at the bus line 25_n, being intermediate between adjacent bus lines 25_n−1 and 25_n+1, which transmit signals with an opposite transition with respect to the signal transmitted through the intermediate bus line 25_n. In the example shown in the figure, a signal with a rising edge propagates through the intermediate bus line 25_n, while signals with falling edge propagate through the adjacent bus lines 25_n−1 and 25_n+1. Hence, highest delay is caused by the coupling capacitance, as previously explained and shown in FIG. 3C. This case is labeled as “WORST” in FIG. 4.

Similarly, the smallest delay occurs at a bus line 25_m, being intermediate between other adjacent bus lines 25_m−1 and 25_m+1, which transmit signal with an identical transition with respect to the signal transmitted through the intermediate bus line 25_m. In other words, a signal with a falling edge propagates through all of the intermediate bus line 25_m and the adjacent bus line 25_m−1 and 25_m−1. In this case, the influence due to the coupling capacitances between adjacent bus lines is the smallest and the delay is the lowest, as previously explained and shown in FIG. 3B. This case is labeled as “BEST” in FIG. 4.

Also in this prior art, the bus lines are split in shorter paths named as Unit Line Path (ULP), in particular, two ULPs including a first unit length path ULP1 and a second unit length path ULP2 are shown in FIG. 4. As previously ULP1 connects the bus signal generator 20 and the repeater 21, while ULP2 connects the repeater 21 and the receiver 22.

After propagation of the signals through the first unit length path ULP1, the “WORST” signal, i.e. the signal of the intermediate bus line 25_n corresponding to the highest delay case, is delayed more than an averagely delayed signal in the first unit length path ULP1, and, likewise, the “BEST” signal, i.e. the signal of the other intermediate bus line 25_m corresponding to the lowest delay case, is delayed less than the averagely delayed signal. In case of no ALSS, at the repeater 21, the “BEST” and the “WORST” signals—and hence the whole bus—suffer from an intermediary skew Tₛ₃ as shown in the dashed circle 40.

The signals then transmit through the second unit length path ULP2 after passing the repeater 21. After propagation of the signals through the second unit length path ULP2, the “WORST” signal is delayed more than the averagely delayed signal, and the “BEST” signal is delayed less than the averagely delayed signal. Therefore, in case of no ALSS, at the receiver 22, the two signals suffer from a final skew Tₛ₄ as shown in the dashed circle 41 and, since they are the fastest and the slowest signals in the bus line, it will be the worst whole bus skew. In particular, the final skew Tₛ₄ is greater than the intermediary skew Tₛ₃, since the “WORST” signal is delayed further during the transmission along the second unit length path ULP2.

It is however well known that, in order to achieve smaller devices, internal shielding should be avoided, the space between the bus lines should be decreased, which causes the adjacent lines coupling capacitance to increase. Consequently, the ALSS induced skew becomes the dominant effect.

Furthermore, since peak power consumption increases as “SKEW” decreases due to almost simultaneous transitions, peak power consumption should be carefully checked.

So, in order to provide correctly working smaller devices, namely, achieving a global area reduction, bus lines pitch increasing should be avoided and, as capacitive load should not increase for high speed devices, internal shielding should be avoided.

### SUMMARY

Embodiments of the invention are directed to an improved bus architecture.

The aim of the proposed bus architecture is to educe the total “SKEW” and namely to reduce the adjacent line simultaneously switching (ALSS) induced “SKEW”, and to reduce the different transition time (DTT) induced “SKEW” as well as to reduce the maximum peak power consumption.

In an embodiment of the invention, a bus architecture for transferring data from a bus signal generator to a receiver comprises a plurality of bus lines comprising a plurality of odd bus lines and a plurality of even bus lines, each of the even bus lines being arranged between adjacent odd bus lines; and at least one repeater coupled with the plurality of bus lines, wherein each of the plurality of bus lines comprises a plurality of unit length paths(ULPs), wherein the repeater is arranged between adjacent ULPs of the bus lines, wherein one of the adjacent ULPs is coupled to one among inputs of the repeater and the other of the adjacent ULPs is coupled to one among outputs of the repeater for each of the bus lines, wherein either of the odd bus lines or the even bus lines are inverting bus lines, and wherein skews of the data transferred to the receiver through the plurality of bus lines are the same as each other.

According to another embodiment of the invention, a bus architecture for transferring data from a bus signal generator to a receiver comprises a plurality of bus lines comprising a plurality of odd bus lines and a plurality of even bus lines, each of the even bus lines being arranged between adjacent odd bus lines; and a plurality of repeaters coupled with the plurality of bus lines, wherein each of the plurality of bus lines comprises a plurality of ULPs (unit length path), wherein each repeater is arranged between adjacent ULPs of the bus lines, wherein one of the adjacent ULPs is coupled to one among inputs of the repeater and the other of the adjacent ULPs is coupled to one among outputs of the repeater for each of the bus lines, wherein each of the repeaters is configured such that the number of ULPs having a rising edge and the number of ULPs having a falling edge is the same for one signal transferred through each of the bus lines, and wherein skews of the data transferred through the plurality of bus lines are different from each other, and the receiver compensates different skews of the data so as to be the same as each other.

### BRIEF DESCRIPTION OF THE DRAWINGS

The characteristics and advantages of the disclosure will be apparent from the following description of embodiments thereof given by way of indicative and non-limiting example with reference to the annexed drawings as follows.

FIG. 1A shows a timing diagram of a signal transition of an ideal bus.

FIG. 1B shows a timing diagram of a signal transition of a real bus.

FIG. 2 shows a bus architecture with no Adjacent Lines Simultaneous Switching (ALSS).

FIGS. 3A to 3C show coupling capacitances between metal paths or bus lines in internally shielded bus architecture and un-shielded bus architecture, respectively.

FIG. 4 shows a typical bus architecture where the ALSS occurs.

FIG. 5 schematically shows a bus architecture according to an embodiment of the present invention.

FIG. 6 shows a test result comparing a conventional bus architecture and a bus architecture according to the embodiment of FIG. 5.

FIGS. 7A and 7B schematically show a bus architecture according to an embodiment of the present invention.

FIG. 8 shows a test result comparing a conventional bus architecture and a bus architecture according to the embodiment of FIG. 7B.

FIG. 9A shows a CMOS circuit charging a bus line.

FIG. 9B shows a metal line parasitic capacitance load model.

FIG. 10A depicts peak current worst case of the conventional bus architecture shown in FIG. 2 in a first condition.

FIG. 10B depicts peak current worst case of the conventional bus architecture shown in FIG. 2 in a second condition.

FIG. 10C depicts peak current worst case of the bus architecture according to the embodiment of FIG. 5.

FIG. 11 depicts peak current worst case of the bus architecture according to the embodiment of FIG. 7B.

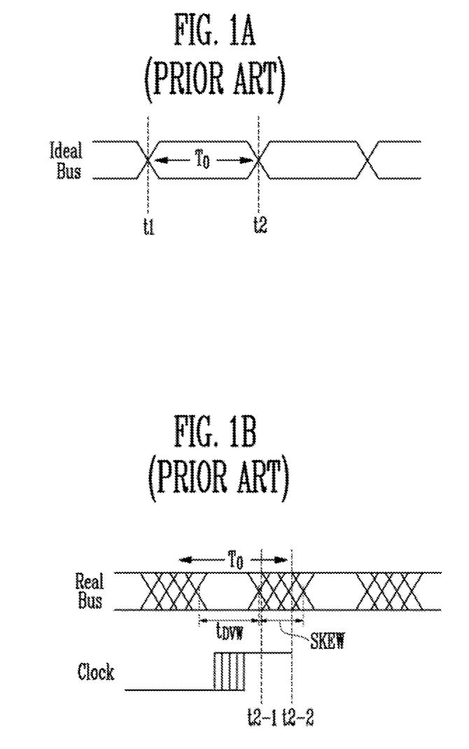

### DETAILED DESCRIPTION

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention. The terms and words used in the specification and claims should not be construed as their ordinary or dictionary sense. On the basis of the principle that the inventor can define the appropriate concept of a term in order to describe his/her own invention in the best way, it should be construed as a meaning and concepts for complying with the technical idea of the present invention. In addition, detailed descriptions of constructions being well known in the art may be omitted to avoid unnecessarily obscuring the clarity of the present invention.

In the drawings, corresponding features are identified by the same reference numerals.

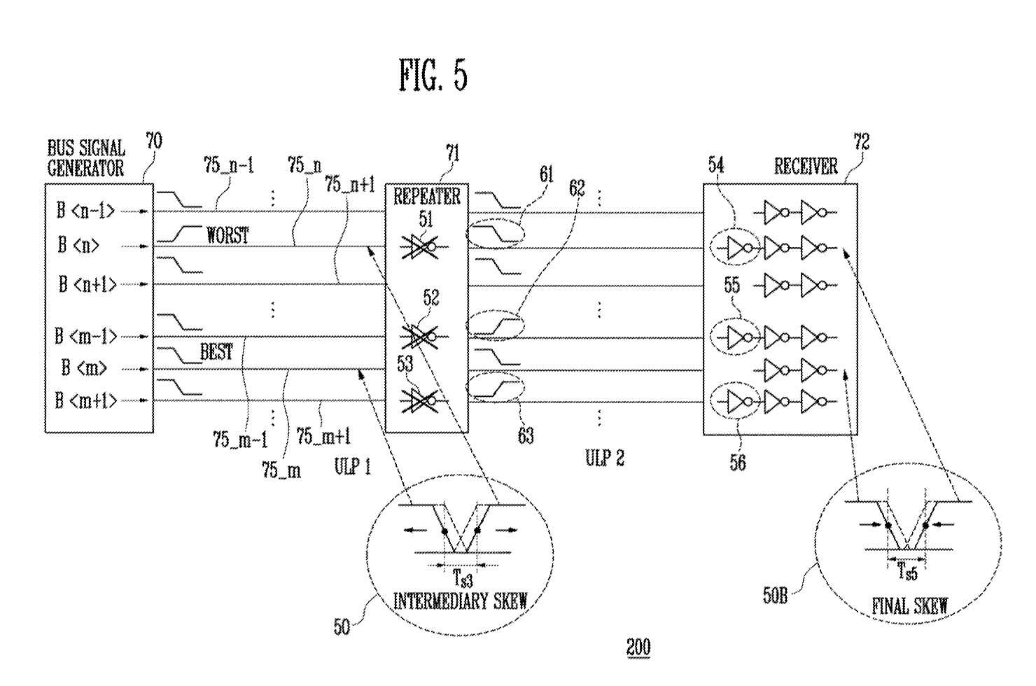

FIG. 5 schematically shows a bus architecture according to an embodiment of the present invention, globally indicated as 200.

The bus architecture 200 comprises a bus signal generator 70 and a receiver 72. The bus architecture 200 may comprise a plurality of bus lines comprising a plurality of odd bus lines and a plurality of even bus lines, each of even bus lines and each of odd lines alternately arranged. In FIG. 5, six bus lines i.e. six metal paths 75_p−1, 75_n, 75_n+1, 75_m−1, 75_m and 75_m+1 are shown.

The bus architecture 200 may comprise at least one repeater 71, in particular a bus repeater, coupled with the plurality of bus lines, each of the plurality of bus lines comprising a plurality of ULPs (unit length paths), the repeater 71 being arranged between adjacent ULPs of the respective bus lines, one of the adjacent ULPs being coupled to the input of the repeater 71 and the other of the adjacent ULPs being coupled to the output of the repeater 71 in the respective bus lines. In FIG. 5, two ULPs, namely ULP1 and ULP2, are shown.

Either of the odd bus lines and the even bus lines may be defined as inverting bus lines. The repeater 71 is additionally arranged to invert a signal provided through its input toward a corresponding output connected to the inverting bus lines. In other words, in one example of the odd bus lines as the inverting bus lines, all of the signals transmitted through odd bus lines are inverted at the repeater 71 and all of the signals transmitted through even bus lines are not inverted at the repeater 71. In an alternative example of the even bus lines as the inverting bus lines, all of the signals transmitting through odd bus lines are not inverted at the repeater 71 and all of the signal transmitting through even bus lines are inverted at the repeater 71.

To restore the inverted signal to the original signal, any one of repeaters (not shown) subsequent to the repeater 71 and the receiver 72 may include an inverter connected to a corresponding inverting bus line. This also allows preventing delay mismatch throughout all bus lines due to a different number of logic gates through which the signals travel.

In FIG. 5, the output from the repeater 71 at the bus lines 75_n , 75_m−1, 75_m+1, i.e. the even bus line exemplified as the inverting bus lines, are inverted signals 61, 62 and 63 with respect to the original signals at the corresponding inputs.

A plurality of inverters are included in the repeater 71. In particular, the repeater 71 usually comprises even number of inverters connected in series at the respective bus lines, in order to restore the polarity of the original signals passing through the corresponding bus lines. Thus, the inversion of the signals can be implemented by removing one inverter at a given locations 51, 52 and 53 in the repeater 71. For this, the repeater 71 may include odd number of inverters at locations where a provided signal needs to be inverted. The provided signal may pass through inputs, to which the odd number of inverters are serially coupled in the repeater 71.

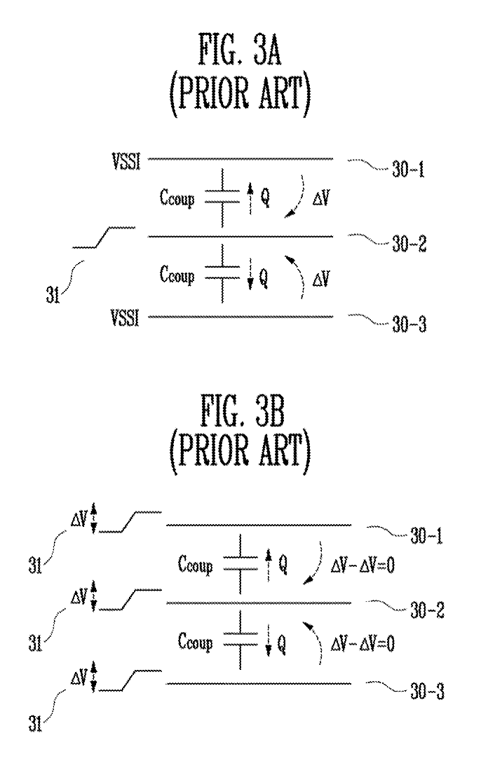

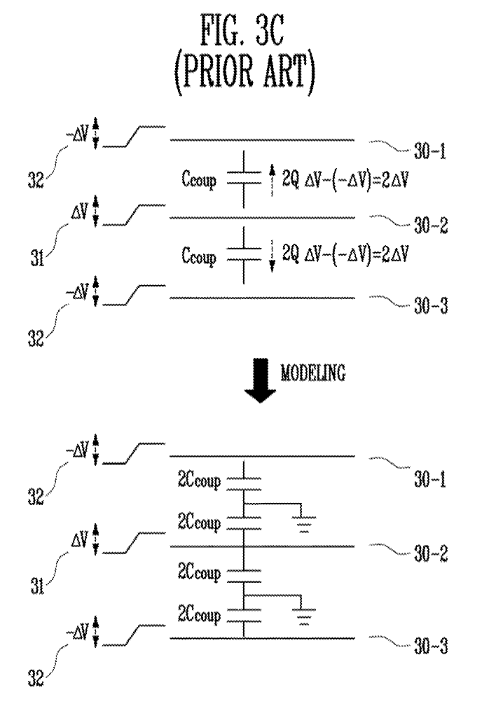

It is thus evident that, in the first unit length path. ULP1, the greatest delay occurs at the second bus line 75_n, since its adjacent bus lines 75_n−1 and 75_n+1 transmit signals with transition opposite to that of the intermediate bus line 75_m. In other words, a signal with rising edge propagates through the intermediate bus line 75_n while signals with falling edge propagate through the adjacent bus lines 75_n−1 and 75_n+1. Highest delay is caused by the coupling capacitances, which are the ones described with reference to FIG. 3C. The signal transmitted through the intermediate bus line 75_n is thus labeled as “WORST” in FIG. 5.

Likewise, still considering the first unit length path ULP1, the smallest delay occurs at the further intermediate bus line 75_m, since its adjacent bus lines 75_m−1 and 75_m+1 transmit signals with transition identical to that of the further intermediate bus line 75_m. In other words, a signal with falling edge propagates through the further intermediate bus line 75_m and the adjacent bus lines 75_m−1 and 75_m+1. In this case, the influence from the coupling capacitances with adjacent bus lines is the smallest, indeed, such coupling capacitances being the ones as described with reference to FIG. B. The signal transmitted through the further intermediate bus line 75_m is thus labeled as “BEST” in FIG. 5.

In other words, after the propagation of signals through the first unit length path ULP1, the “WORST” signal is delayed more than an averagely delayed signal in the first unit length path ULP1, and the “BEST” signal is delayed less than the averagely delayed signal. Therefore, in case of no ALSS, at the repeater 71, the two signals suffer from an intermediary skew Tₛ₃ as shown in the dashed circle 50.

The signals are then transmitted through the second unit length path ULP2 after passing the repeater 71. By the arrangement of the odd numbers of inverters at the locations 51, 52 and 53 in the repeater 71 according to the embodiment of the present invention, the signals 61, 62 and 63 at the even bus lines 75_n. 75_m−1 and 75_m+1, are respectively inverted, while the rest of signals at the odd bus lines 75_n−1, 75_n+1 and 75_m are not inverted. Therefore, the “WORST” signal 61 of the intermediate (i.e., even) bus line 75_n now has the same transition with respect to the two signals of the adjacent (i.e., odd) bus lines 75_n−1 and 75_n+1, and the “BEST” signal of the further intermediate (i.e., odd) bus line 75_m now has the opposite transition with respect to the two signals 62 and 64 of the adjacent (i.e., even) bus lines 75_m−1 and 75_m−1.

In this way, advantageously according to the embodiment of the present invention, after the propagation of signals through the second unit length path ULP2, the “WORST” signal at the second bus line 75_n is delayed less than an averagely delayed signal in the second unit length path ULP2, and the “BEST” signal at the fifth bus line 75_m is delayed more than the averagely delayed signal. Therefore, in case of no ALSS, at the receiver 72, the two signals suffer from a final skew Tₛ₅ as shown in the dashed circle 54B.

In particular, it should be underlined that, according to the embodiment of the present invention, the final skew Tₛ₅ is smaller than the intermediary skew Tₛ₃, since the “BEST” signal is delayed more than the “WORST” signal in the second unit length path ULP2. The delay of signals of the bus lines as a whole thus balanced to reduce skew in the proposed bus architecture. In other words, advantageously according to the embodiment of the present invention, the coupling capacitance balance of the bus lines as a whole can be achieved to reduce skew in such a bus architecture.

Additionally, the bus architecture 200 may comprise a grounded bus line arranged out of the outmost bus line of the plurality of bus lines for implementing an external shielding (not shown). The adjacent ULPs in the adjacent bus lines may have a similar length, width, and space therebetween.

FIG. 6 shows a test result comparing a conventional bus architecture and the bus architecture according to the embodiment as shown in FIG. 5.

The test has been performed in various PVT conditions, PVT being an abbreviation meaning Process, Voltage and Temperature, as above indicated. More particularly:

Process conditions are indicated as SS, TS, FS, ST, TT, FT, SF, TF and FF (being F=Fast, T=Typical, S=Slow).

Temperature conditions are −40° C., 25° C. and 90 ° C.

Voltage conditions are 1.6V, 1.8V and 2.05V.

It is remarked that the above listed conditions are given only by way of a non-limiting example.

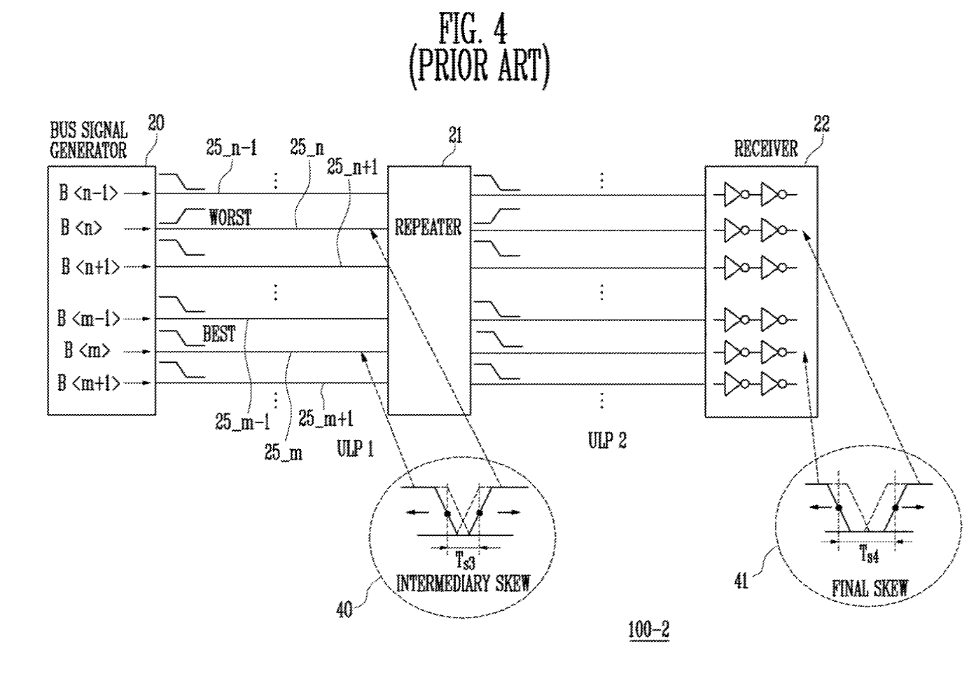

In FIG. 6, X-axis indicates PVT conditions, while Y-axis indicates skew values. A first graph 66 corresponds to a typical bus architecture with ALSS of FIG. 4, a second graph 67 corresponds to a typical shielded bus architecture which does not suffer from ALSS, and a third graph 68 related to the proposed bus architecture with ALSS according to the embodiment of FIG. 5.

As shown in the dashed circle 65, there is a skew increasing of 2 ns between the typical bus architecture with ALSS (represented by graph 66) and the bus architecture according to the embodiment (represented by graph 68).

The bus architecture according to the embodiment (represented by graph 68) has a similar skew with the typical bus architecture without ALSS (represented by graph 67), i.e. a bus architecture implementing internal shielding through ground bus line interposed in each valid bus lines, which increases the area occupied by the bus lines.

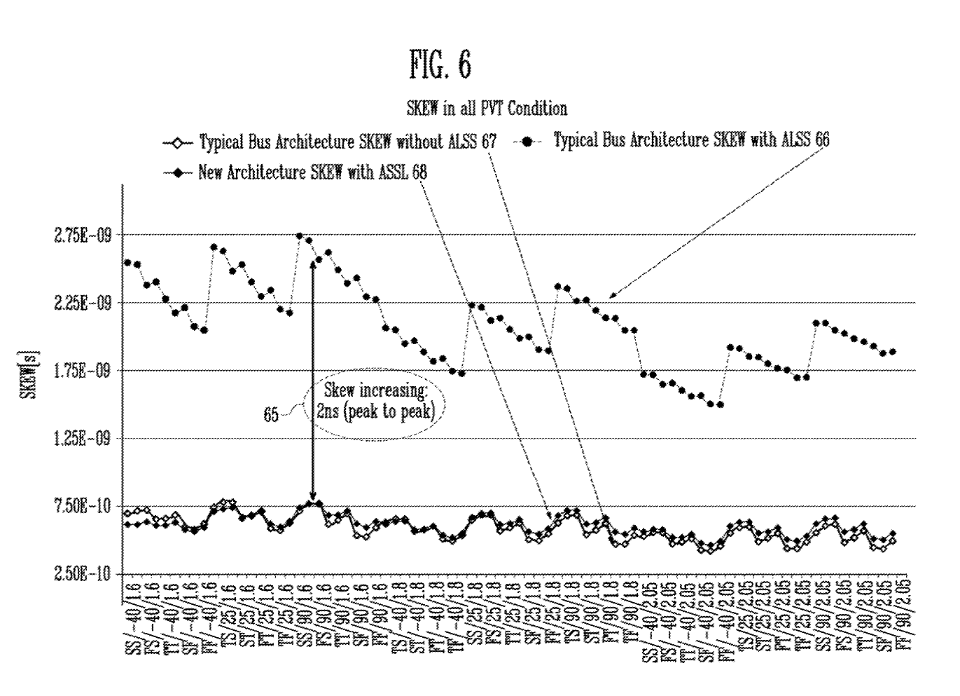

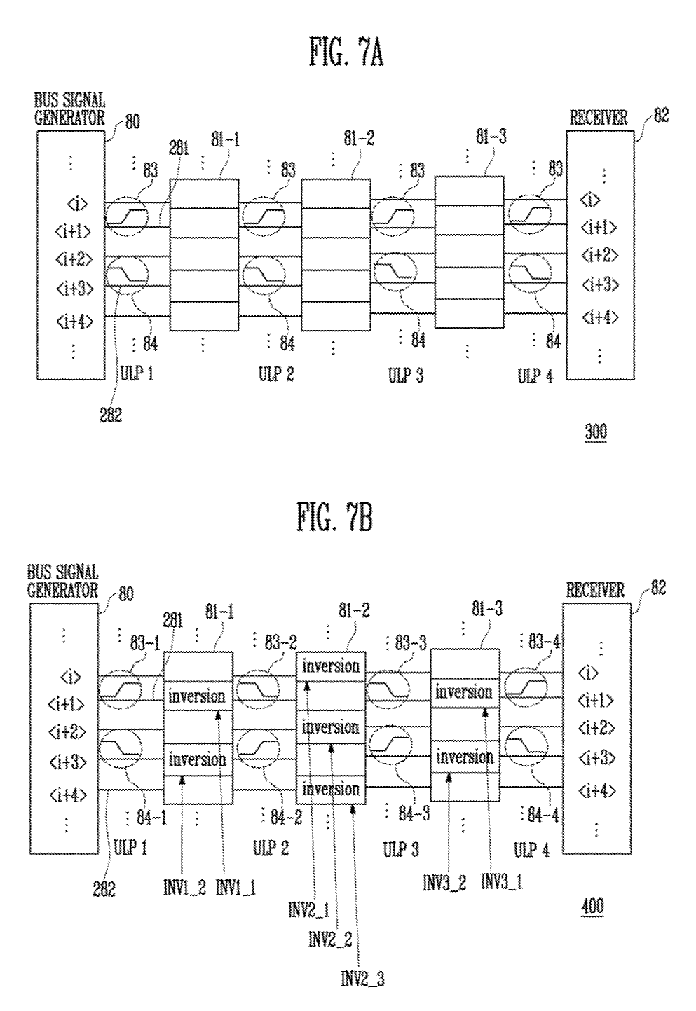

FIG. 7B schematically shows a bus architecture according to another embodiment of the present invention, globally indicated as 400.

FIG. 7A schematically shows a typical bus architecture, globally indicated as 300, so as to explain the differences with respect to the bus architecture according to the embodiment of FIG. 7B.

More particularly, the bus architecture 300 shown in FIG. 7A comprises a bus signal generator 80 and a receiver 22, as well as a plurality of repeaters therebetween, including a first repeater 81-1, a second repeater 81-2 a third repeater 81-3. The bus architecture 300 may comprise a plurality of bus lines comprising a plurality of odd bus lines and a plurality of even bus lines, each of the even bus lines being arranged between adjacent odd bus lines. In FIG. 7A, five bus lines are shown.

The bus architecture 300 may comprise one or more repeaters 81-1, 81-2 and 81-3 coupled with the plurality of the bus lines, each of the plurality of bus lines comprising a plurality of ULPs (unit length paths), the repeater being arranged between adjacent ULPs of the bus lines, in a repeated configuration with respect to the configuration of the architecture of FIG. 4. In FIG. 7A, four ULPs ULP1 to ULP4 are shown for the respective bus lines.

More particularly, a signal 83 with rising edge is transmitted through a bus line 281, while a further signal 84 with falling edge is transmitted through a further bus line 282.

The bus architecture 400 according to the embodiment of FIG. 7B shows a same configuration as the architecture 300 of FIG. 7A, the number of ULPs in each bus line being a multiple of four, namely four in FIG.7B. According to the embodiment of FIG. 7B, each of the repeaters 81-1, 81-2 and 81-3 is configured such that the number of ULPs having a rising edge and the number of ULPs having a falling edge is the same for each signal transferred through each of the bus lines.

For example, the signal 83 transmitted through the first bus line 281 can be a signal with rising edges 83-1 and 83-4 in the first and fourth ULPs ULP1 and ULP4, and a signal with falling edges 83-2 and 83-3 in the second and third ULPs ULP2 and ULP3. This is achieved by respective inversions INV1_1 and INV3_1 introduced at: the first repeater 81-1 and at the third repeater 81-3, respectively, in correspondence of the bus line 281.

The further signal 84 transmitted through the second bus fine 282 can be a signal with rising edges 84-2 and 84-3 in the second and third ULPs ULP2 and ULP3 and a signal with falling edges 84-1 and 84-4 in the first and fourth ULPs ULP1 and ULP4. This is achieved by respective inversions INV1_2 and INV3_2 introduced at the first repeater 81-1 and at the third repeater 81-3, respectively, in correspondence of the further bus line 282.

Moreover, in the bus architecture 400 according to the embodiment of FIG. 7B, adjacent repeaters are configured to invert signal received at their inputs toward their outputs at locations associated with even bus lines and odd bus lines, respectively. In the example shown. FIG. 7B, the first repeater 81_1 is configured to invert its inputted signal to its corresponding output at locations associated with even bus lines through inversions INV1_1 and INV1_2, and the second repeater 81_2 is configured to invert its inputted signal to its corresponding output at locations associated with the odd bus lines through inversions INV2_1, INV2_2 and INV2_3.

In this way, the first repeater 81-1 can invert a signal at an even bus line and does not invert a signal at an odd bus line adjacent to the even bus line in downward direction, and this arrangement repeats through the whole bus lines. The second repeater 81-2 inverts signal in an opposite way, namely, inverts signals at the odd bus lines that are not inverted by the first repeater 81-1. After the second repeater 81-2, a repeater, namely the third repeater 81_3, having the same arrangement as the first repeater 81-1 may follows.

In the typical bus architecture as depicted in FIG. 7A, due to the semiconductor width/length ratio (W/L), the charge mobility (p) and threshold voltage variations with Process-Voltage-Temperature (PVT) conditions variation, the signals having a rising edge can be faster than the signals having a falling edge or vice versa. Therefore, a different transition times (DTT) mismatch may make the “SKEW” to increase.

By using the bus architecture according to the embodiment of the present invention, as shown in FIG. 7B, in addition to the advantages of the embodiment of FIG. 5, the DTT mismatch is also balanced and thus the “SKEW” may not increase.

FIG. 8 shows a test result comparing the typical bus architecture of FIG. 7A and the bus architecture according to the embodiment of FIG. 7B.

The test has been performed in various P conditions as follows.

Process conditions are indicated as SS, TS, FS, ST, TT, FT, SF, TF and FF (being F=Fast, T=Typical, S=Slow).

Temperature conditions are −40° C., 25° C. and 90° C.

Voltage conditions are 1. 6V, 1.8V and 2.05V.

It is remarked that also the above listed conditions are given only by way of a non-limiting example.

In FIG. 8, X-axis indicates PVT conditions while Y-axis indicates skew values. A first graph 87 corresponds to a typical bus architecture with ALSS of FIG. 7A, a second graph 86 corresponds to a typical shielded bus architecture which does not suffer from ALSS, and a third graph 88 corresponds to the proposed bus architecture with ALSS according to the embodiment of FIG. 7B.

As shown in the dashed circle 89-1, there is a skew increasing of 1.7 ns between the typical bus architecture with ALSS (represented by graph 86) and the bus architecture according to the embodiment of FIG. 7B (represented by graph 88).

The bus architecture 400 has a similar skew with the typical bus architecture without ALSS, but the skew is slightly improved to 120 ps as shown in the dashed circle 89-2. As explained above, the typical bus architecture without ALSS should implement internal shielding, i.e. a ground bus line interposed in each valid bus lines, which increases the area occupied by the bus lines.

It should be remarked that the proposed bus architectures can be used also in case of an initial inversion, in particular at an inverting transmitter, and a following inversion along the bus lines at a corresponding repeater.

Hereinafter, more precise theoretical evaluations for the embodiments are explained to show the advantage of the embodiments. Peak current consumption of the bus architecture will be deeply analyzed.

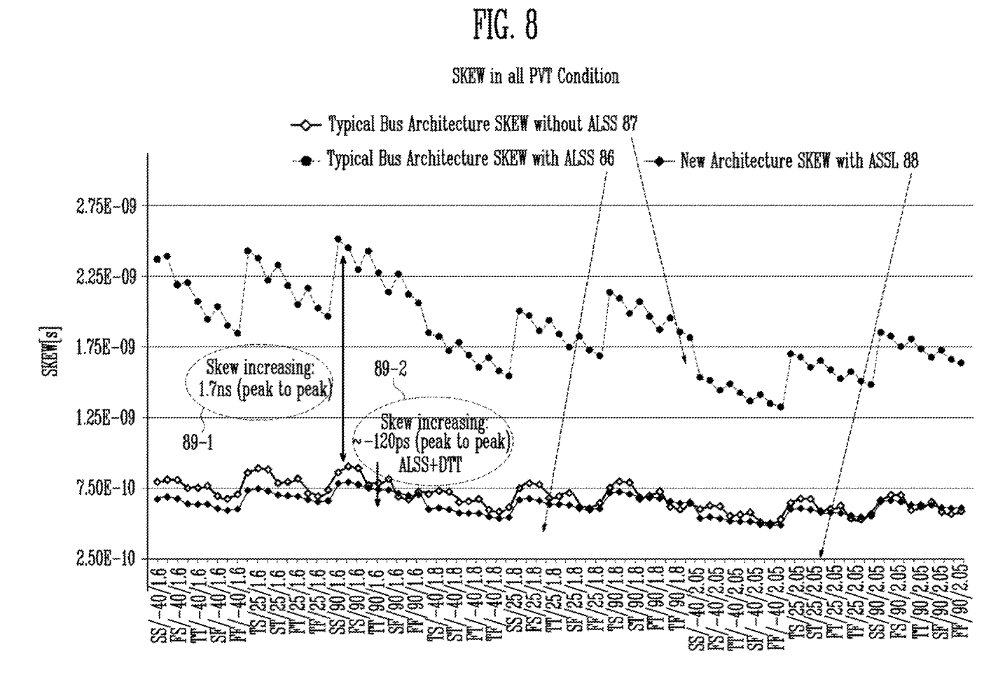

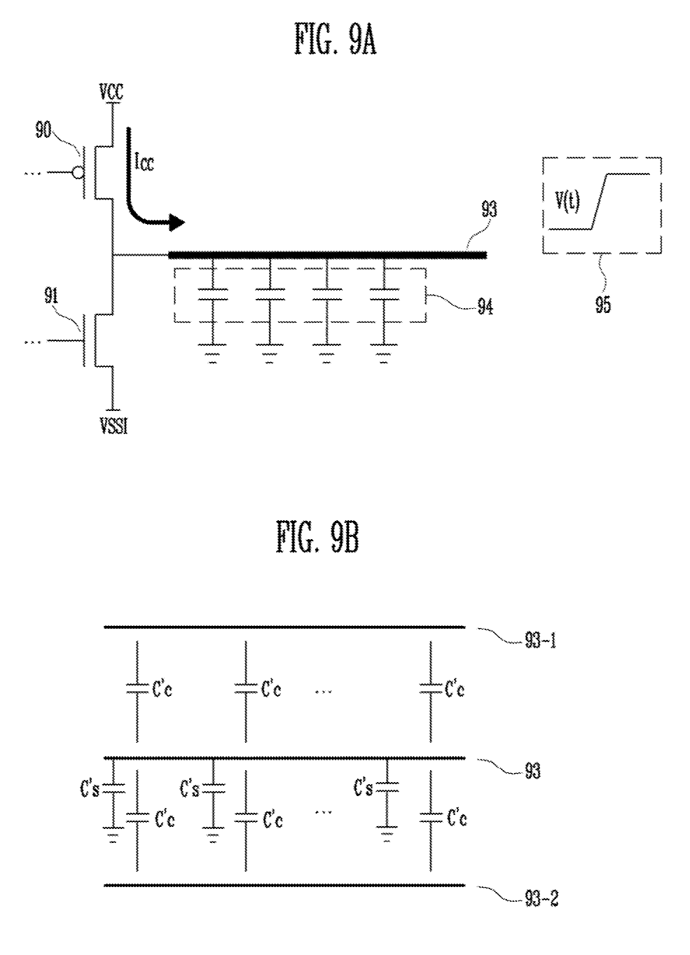

FIG. 9A shows a Complementary metal-oxide semiconductor (CMOS) switching circuit charging a bus line.

A CMOS usually comprises a p-type MOSFET 90 and an n-type MOSFET 91 connected in series between a supply voltage VCC and ground VSSI. CMOS can serve, for instance, as an inverter.

A bus line 93, being a metal line, is charged by the CMOS inverter. The bus line 93 has a load capacitance, globally indicated as 94. When the metal line, i.e. the bus line 93, is charged, the voltage of the bus line 93 changes as shown in the dashed rectangle 95. More particularly, a current I_{CC} flows through the p-type MOSFET 90 and charges the bus line 93.

A peak current consumption occurs mainly due to (a) charging up the load capacitance 94 by the flowing current Icc and (b) wasted current, namely, a leakage current flowing through both of the p-type MOSFET 90 and the n-type MOSFET 91 when both are simultaneously on. Moreover, it is important to ensure that the voltage generator (i.e. VCC) provides, during the ON phase of the PMOS transistor (i.e. when the capacitive load is charged), a certain current with the constant voltage VCC. An amount of the provided current corresponds to a total, power amount. In a similar manner during the ON phase of the NMOS transistor (i.e. when the capacitive load is discharged), neither current nor power are required for the voltage generator since the PMOS transistor is turned off. Hence, also the current or power consumption is to be evaluated. In other words, when the PMOS transistor is ON, the voltage generator VCC provides a current to charge the bus line; being VCC constant, the amount of the provided current substantially corresponds to the consumed power amount. Similarly, when the NMOS transistor is ON and the PMOS transistor is OFF, the voltage generator VCC does not provide any current, and hence no power consumption occurs. Hence, in order to calculate the power or current consumption, only the phase wherein the PMOS transistor is ON matters.

FIG. 9B shows a metal line parasitic capacitance load model.

Referring to FIG. 9B, a parameter C′ₛ is capacitance per unit length between the metal line, i.e. bus line, and all below and above lines and layers. A parameter C′_{c} is capacitance per unit length between adjacent metal lines 93-1 and 93-2. These notations will be used for the explanation of the modeling, hereinafter.

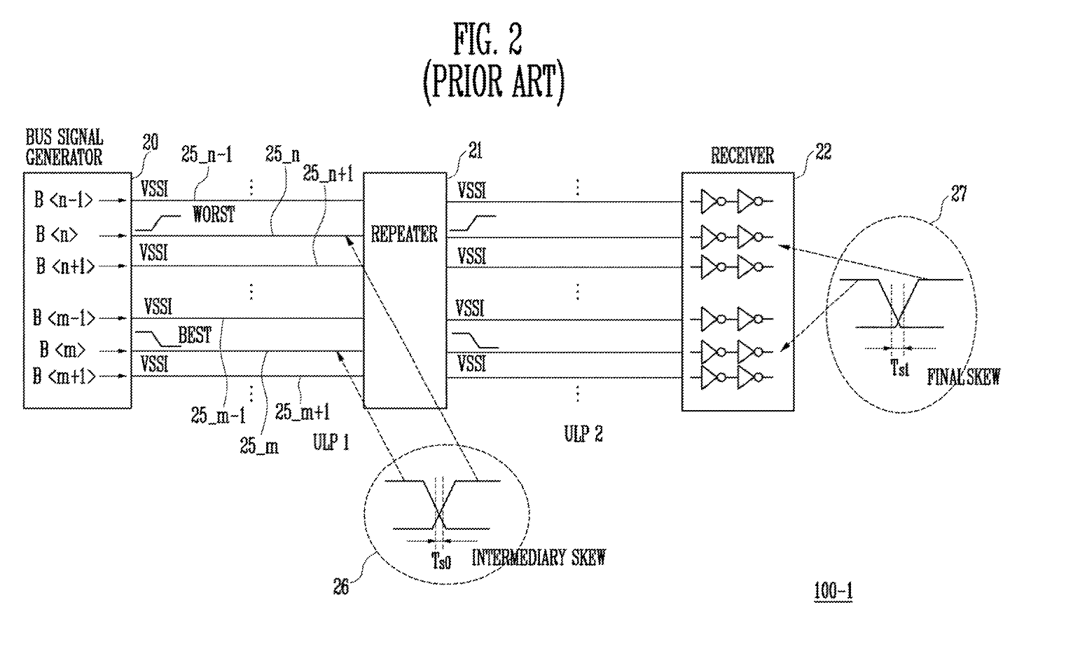

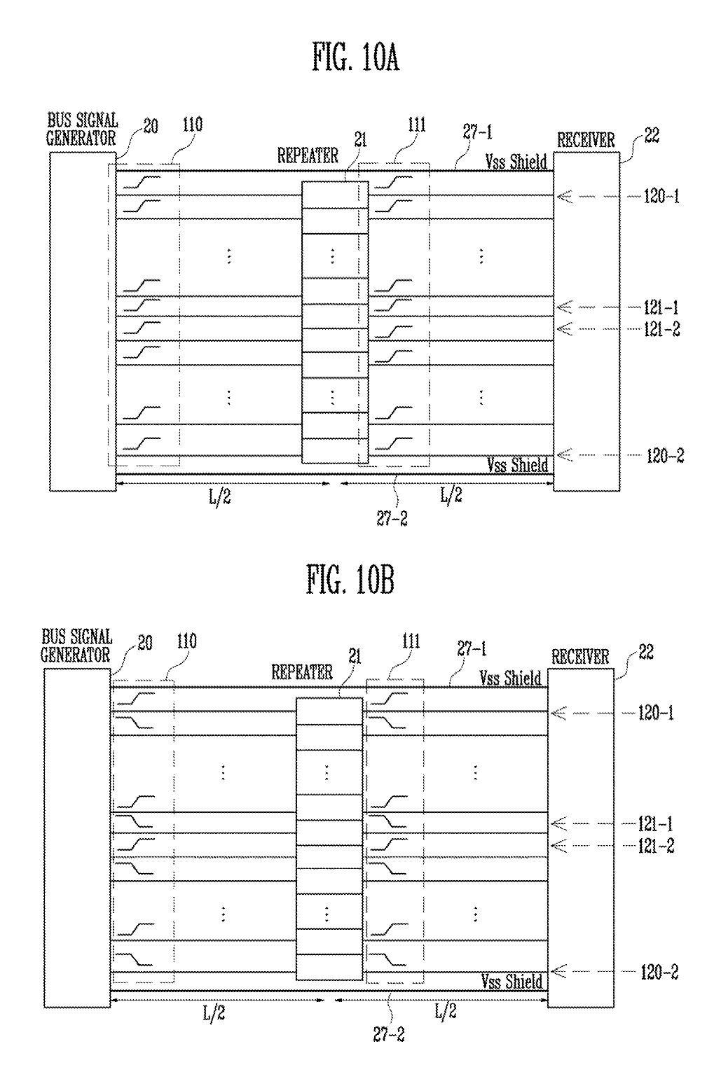

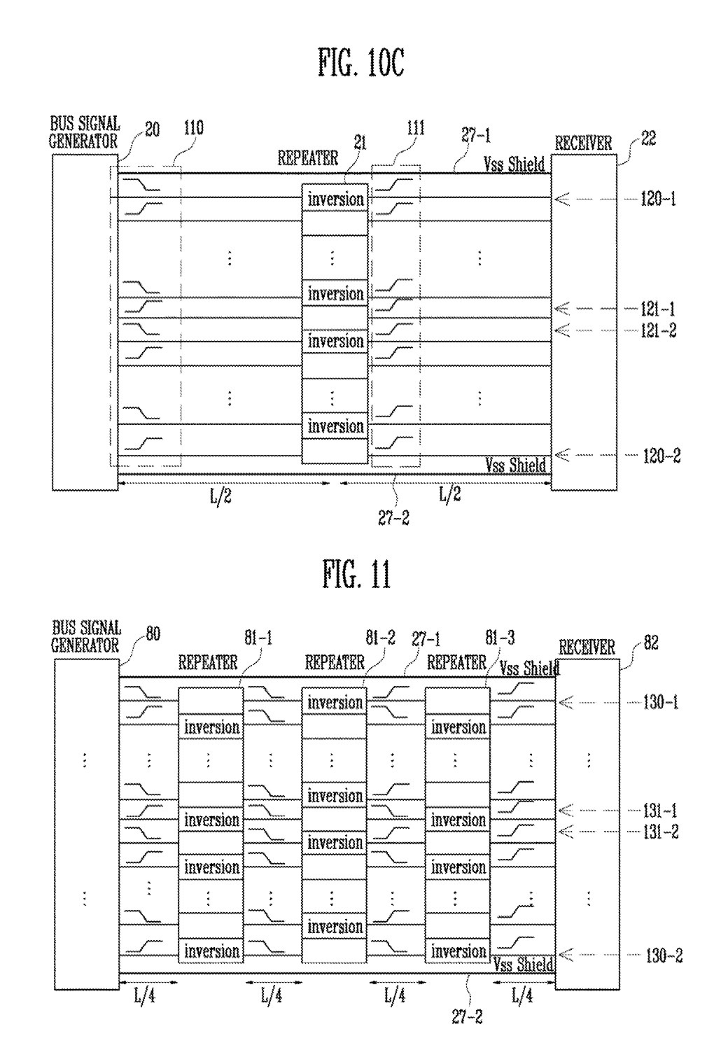

FIG. 10A depicts a peak current worst case of a typical bus architecture of FIG. 2, where C′ₛ is much greater than C′_{c} (C′ₛ>>C′_{c}).

Lines 27-1 and 27-2 are grounded lines and indicated as “Vss shield” in FIG. 10A.

The worst case, corresponding to the peak current, occurs when all of the signals have rising edges, as shown in the dashed rectangle 110. These signals are not inverted as shown in the dashed rectangle 111.

The p-type MOSFET driver load for the outmost arranged metal lines or bus lines 120-1 and 120-2 is thus equal to 2*C′ₛ*L/2+2*C′_{c}*L/2 for each metal line. L is the total metal length of the corresponding metal lines. There is no coupling capacitance between adjacent bus lines since signals having the same polarity propagate. Each of the outmost bus lines 120-1 and 120-2 has a coupling capacitance with respect to each of the grounded lines 27-1 and 27-2.

The p-type MOSFET driver load for the other bus lines, e.g. 121-1 and 121-2, is equal to 2*C′ₛ*L/2. There is no effect from adjacent bus lines since they are propagating signal having a same polarity, i.e. rising edges, as shown in the dashed rectangles 110 and 111.

The total p-type MOSFET driver load n this case is thus equal to (4*C′ₛ*L/2)*(n/2−1)+(4*C′ₛ*L/2+4*C′_{c}*L/2), which is equal to C′ₛ*L*n+2*C′^{c}*L. n is the number of bus lines.

FIG. 10B depicts a peak current worst case of a typical bus architecture of FIG. 2, where C′ₛ>>C′_{c} is not met, that is to say, C′ₛ is not so greater than C′_{c}. In this case, the capacitance C′_{c} also contributes to the p-type MOSFET load.

The worst case, corresponding to the peak current, occurs when the signals of odd lines have rising edges and the signals of even lines have falling edge, or vice versa, as shown in the dashed rectangle 110 These signals are not inverted as shown in the dashed rectangle 111.

The p-type MOSFET driver load for the outmost arranged metal line or bus line 120-1 is equal to 2*C′ₛ*L/2+4*C′_{c}*L/2+2*C′_{c}*L/2. The p-type MOSFET driver load for the bus line 120-2, i.e. the bottommost bus line, is instead equal to 0, because p-type MOSFET 90 as shown in FIG. 9A is switched off during the discharge phase, i.e. the failing edge of the corresponding signal on the bus line. In a similar manner, the p-type MOSFET driver load for the bus line 121-1 is equal to 0.

For the bus line 121-2 where a signal with rising edge propagates, the driver load is instead equal to 2*C′ₛ*L/2+8*C′_{c}*L/2.

The total p-type MOSFET driver load in this case is (2*C′ₛ*L/2+8*C′_{c}*L/2)*(n/2−1)+(2*C′ₛ*L/2+6*C′_{c}*L/2), which is equal to 1/2C′ₛ*L*n+2C′_{c}*L(n−1/2).

FIG. 10C depicts a peak current worst case of the bus architecture according to the embodiment shown in FIG. 5.

In this bus architecture, the worst pattern doesn't change no matter C′ₛ is much greater than C′_{c} (Cₛ>>C_{c}) or C′ₛ is not so greater than C′_{c} (not Cₛ>>C_{c}). This is because if in the first ULP all signals have the same transition, in the second ULP they have opposite transition, and vice versa.

The p-type MOSFET driver load for the outmost arranged metal line or bus line 120-1 is equal to C′ₛ*L/2+C′_{c}*L/2. The p-type MOSFET driver load for the other outmost bus line 120-2 is equal to 2*C′ₛ *L/2+2*C′_{c}*L/2+2*C′_{c}*L/2.

The p-type MOSFET driver load for the bus lines whose signal is not inverted, i.e. the bus line 121-1, is equal to 2*C′ₛ*L/2+4*C′_{c}L/2, while the p-type MOSTFET driver load for the bus lines whose signal is inverted, i.e. the bus line 121-2, is equal to C′ₛL/2.

The total p-type MOSFET driver load, also indicated as pMOS load, is (3*C′ₛ*L/2+4*C′_{c}*L/2)*(n/2−1)+(3*C′ₛ*L/2+5*C′_{c}*L/2), which is equal to 3/4C′ₛ*L*n+C′_{c}*L(n+1/2).

To summarize, the total p-type MOSFET load is as follows:

Typical bus architecture shown in FIG. 10A (C′ₛ>>C′_{c}): (C′ₛ*n+2*C′_{c})*L

Typical bus architecture shown in FIG. 10B (not C′ₛ>>C_{c}): (1/2C′ₛ*n+2C′_{c}*(n−1/2))*L

The bus architecture shown in FIG. 10C according to the embodiment: (3/4C′ₛ*n+C′_{c}*(n+1/2)) L

To compare the test result, considering C′ₛ much greater than C′_{c} (C′ₛ>>C′_{c}):

the pMOS load for the typical bus architecture of FIG. 10A: C′ₛ*n*L; and

the pMOS load for the bus architecture of the embodiment according to FIG. 10C: 3/4C′ₛ*n*L.

Therefore, the pMOS load for the bus architecture of embodiment according to FIG. 10C/the pMOS load for the typical bus architecture of FIG. 10A is approximately 3/4.

Further, to compare the test result, considering C's not so greater than C′_{c} (C′ₛ≈C′_{c}):

the pMOS load for a typical bus architecture of FIG. 10B: C′ₛ*n*L*(5/2n−1); and

the pMOS load for the bus architecture of the embodiment according to FIG. 10C: C′ₛ*n*L*(7/4n+1)

Therefore, the pMOS load for the bus architecture of embodiment according to FIG. 10C/the pMOS load for the typical bus architecture of FIG. 10B is approximately 7/10.

Further, to compare the test result, and considering C′ₛ much smaller than C′_{c} (C′ₛ<<C′_{c}):

the pMOS load for the typical bus architecture of FIG. 10B: 2C′_{c}*(n−1/2)*L; and

the pMOS load for the bus architecture of the embodiment according to FIG. 10C: C′_{c}*(n+1/2)*L.

Therefore, the pMOS load for the bus architecture of embodiment according to FIG. 10C/the pMOS load for the typical bus architecture of FIG. 10B is approximately 1/2.

As shown in the above analysis, in the bus architecture according to the embodiment of the present invention, the total bus capacitance seen during rising edge in the worst case is always less than the one in the typical bus architecture. This results in lower maximum peak power consumption.

FIG. 11 depicts a peak current worst case of the bus architecture of FIG. 7B according to the embodiment of the present invention, the same numbering having been used.

The p-type MOSFET driver load for the outmost arranged metal lines or bus lines 130-1 and 30-2 is equal to 2C′ₛ*L/4+2C′_{c}*L/4+2C′_{c}*L/4 for each bus line. The p-type MOSFET driver load for the other bus lines, e.g. the bus lines 131-1 and 131-2, is equal to 2C′ₛ*L/4+2C′_{c}*L/4+2C′_{c}*L/4.

The total p-type MOSFET driver load in this case is (4*C′ₛ*L/4+8*C′_{c}*L/4)*(n/2−1)+(4*C′ₛ*L/4+8*C′_{c}*l/4), which is equal to 1/2C′ₛ*L*n+C′_{c}*L*n.

To summarize, the total p-type MOSFET load is as follows:

the bus architecture shown in FIG. 10C repeater) is 3/4C′ₛ*L*n+C′_{c}*L(n+1/2); and

the bus architecture shown in FIG. 11 (3 repeater) is 1/2C′ₛ*L*n+C′_{c}*L*n.

Therefore, the pMOS load of the bus architecture of FIG. 11/the pMOS load of the bus architecture of FIG. 10C is approximately 2/3.

It is thus concluded that the embodiment of FIG. 11, corresponding to the one of FIG. 7B, introduces a further improvement in terms of peak power consumption.

The bus architecture according to the embodiments is thus able to reduce the Skew induced by the Adjacent Lines Simultaneous Switching (ALSS) and well as the Skew induced by Different Transition Times (DTT), also to reduce the maximum peak current consumption, as above indicated.

From the foregoing, it will be appreciated that although specific embodiments of the invention have been described herein for purposes of illustration, various modifications may be made without deviating from the spirit and scope of the invention. Accordingly, the invention is not limited except as by the appended claims.

What is claimed is:

1. A bus architecture for transferring data from a bus signal generator to a receiver, the bus architecture comprising:
a plurality of bus lines comprising a plurality of odd bus lines and a plurality of even bus lines, each of the even bus lines being arranged between adjacent odd bus lines; and
at least one repeater coupled with the plurality of bus lines,
wherein each of the plurality of bus lines comprises a plurality of unit length paths (ULPs),
wherein the repeater is arranged between adjacent ULPs of the bus lines,
wherein one of the adjacent ULPs is coupled to one among inputs of the repeater and the other of the adjacent ULPs is coupled to one among outputs of the repeater for each of the bus lines,
wherein either of the odd bus lines or the even bus lines are inverting bus lines, and
wherein skews of the data transferred to the receiver through the plurality of bus lines are the same as each other.

2. The bus architecture of claim 1, wherein the repeater its arranged to invert a signal provided through a corresponding input thereof from one among the inverting bus lines and outputs the inverted signal through a corresponding output thereof to the inverting bus line.

3. The bus architecture of claim 1,
wherein the repeater comprises a number of inverters for each of the bus lines, and
wherein the repeater comprises an odd number of inverters at locations associated with the inverting bus lines and suitable for inverting a signal provided thereto.

4. The bus architecture of claim 3, wherein the repeater comprises an even number of inverters at locations associated with the bus lines other than the inverting bus lines and suitable for keeping a signal provided thereto.

5. The bus architecture of claim 1, wherein the receiver includes an inverter for each of the inverting bus lines and suitable for inverting a signal provided thereto so as to retrieve a polarity of a signal originally provided from the bus signal generator.

6. The bus architecture of claim 1, further comprising at least a grounded bus line arranged out of the outmost bus line of the plurality bus lines for external shielding.

7. The bus architecture of claim 1, further comprising two grounded bus lines arranged out of the outmost bus lines of the plurality bus lines for external shielding.

8. A bus architecture for transferring data from a bus signal generator to a receiver, the bus architecture comprising:
a plurality of bus lines comprising a plurality of odd bus lines and a plurality of even bus lines, each of the even bus lines being arranged between adjacent odd bus lines; and
a plurality of repeaters coupled with the plurality of bus lines,
wherein each of the plurality of bus lines comprises a plurality of ULPs (unit length path),
wherein each repeater is arranged between adjacent ULPs of the bus lines,
wherein one of the adjacent ULPs is coupled to one among inputs of the repeater and the other of the adjacent ULPs is coupled to one among outputs of the repeater for each of the bus lines,
wherein each of the repeaters is configured such that the number of ULPs having a rising edge and the number of ULPs having a falling edge is the same for one signal transferred through each of the bus lines, and
wherein skews of the data transferred through the plurality of bus lines are different from each other, and the receiver compensates different skews of the data so as to be the same as each other.

9. The bus architecture of claim 8, herein the number of ULPs in each bus line is a multiple of four.

10. The bus architecture of claim 8,
wherein the repeaters include first repeater coupled to one among the even bus lines through input and output thereof and second repeaters adjacent to the first repeater and coupled to one among the odd bus lines through input and output thereof,
wherein the first repeater inverts a signal provided to the input thereof, and
wherein the second repeater inverts a signal provided to the input thereof.

11. The bus architecture of claim 8,
wherein the repeaters include first repeater coupled to one among the odd bus lines through input and output: thereof and second repeaters adjacent to the first repeater and coupled to one among the even bus lines through input and output thereof,
wherein the first repeater inverts a signal provided to the input thereof, and
wherein the second repeater inverts a signal provided to the input thereof.

12. The bus architecture of claim 8, wherein the receiver includes a plurality of inverters to retrieve a polarity of a signal originally provided from the bus signal generator.

13. The bus architecture of claim 8, wherein adjacent ULPs in adjacent bus lines have a similar characteristic, the characteristic including at least one of length, width, and space between bus lines.

14. The bus architecture of claim 8 further comprising at least a grounded bus line arranged out of the outmost bus line of the plurality bus lines for external shielding.

15. The bus architecture of claim 8, further comprising two grounded bus lines arranged out of the outmost bus lines of the plurality bus lines for external shielding.
